(19) United States
(12) Patent Application Publication
(10) Pub. No.: US 2012/0049020 A1
(43) Pub. Date: Mar. 1, 2012

(54) HOLDER FOR VARIABLE SIZES OF TOOLS AND IMPLEMENTS

(76) Inventor: Daniel F. Stock, Belleville, IL (US)

(21) Appl. No.: 13/117,398

(22) Filed: May 27, 2011

Related U.S. Application Data
(60) Provisional application No. 61/378,573, filed on Aug. 31, 2010.

(51) Int. Cl. F16M 13/02; F16B 2/10; H01F 7/02; F16M 13/00

(52) U.S. Cl. 248/206.5; 248/316.5; 248/224.8

(57) ABSTRACT

A holder for securing objects having a plate for securing to a surface and a pair of opposed grippers rotatably mounted on the plate. The grippers are mirror images of each other and configured with a body, a heel on the butt end of the body and an upwardly arcing nose on the body opposite the heel with a curved gripping surface extending between the heel and the nose. The grippers are biased toward each other such that noses abut each other when there is no object between the grippers. An object to be secured is inserted between the grippers and the grippers rotate apart to accommodate the object and the biasing spring urges the grippers towards each other to secure the object between the grippers.

### CROSS-REFERENCE TO RELATED APPLICATIONS

This application claims the benefit of provisional application Ser. No. 61/378.573, filed Aug. 31, 2010, which is incorporated herein by reference.

### STATEMENT REGARDING FEDERALLY SPONSORED RESEARCH OR DEVELOPMENT

Not applicable.

### BACKGROUND OF THE INVENTION

The invention relates generally to apparatus for securing and storing objects, such as tools or other implements, and more particularly to an apparatus or holder that can be attached or mounted on a surface and employs rotatable grippers to secure tools or other implements of variable sizes ranging from very thin or narrow like a fishing rod to more substantial such as shovel or baseball bat.

Holders for securing and storing objects such as tools are well known. For example, holders that mount to a surface, such as a wall, and accommodate one or more tools or other implements are known. In general, such devices include a base, which is generally flat and elongated, that is attached to the surface with screws or the like. There generally is a plurality of fasteners or clips attached to the base and spaced equidistantly apart. These common devices often are used in garages and storage sheds to secure tools such as shovels or rakes or. They can be used on a wall or in a closet to store domestic tools such as brooms or mops. In any event, these known devices lack versatility since the fasteners or clips are sized to accommodate the most common of tools or other objects. For example, the fasteners or clips are sized to accommodate mop or broom handles or perhaps a shovel. Objects that are much larger in diameter or heavier, such as a baseball bat, will not fit in the clip or fastener. Similarly, a smaller object, such as small diameter fishing pole, will simply slide through the fastener or clip.

It would be advantageous, therefore, if a single holder was available that could accommodate a broader range of sizes of tools or other implements.

### SUMMARY OF THE INVENTION

A holder for securing objects comprising a base plate for securing to a surface and a pair of opposed grippers rotatably mounted on the plate. The grippers are mirror images of each other and configured having a body, a heel, an upwardly arcing nose section opposite the heel with a curved or arcuate gripping surface between the heel and the nose. The grippers are biased toward each other such that noses abut each other when there is no object between the grippers. The grippers are formed from rubber having a relatively high coefficient of friction. The gripping surface can have scoring or grooves. An object to be secured is inserted up between the grippers and the grippers rotate apart to accommodate the object between the gripping surfaces. The biasing means, for example a spring, biases the grippers towards each other to secure the object between the grippers. The downward force of the object between the grippers draws the grippers toward each other to enhance the gripping pressure on the object.

### BRIEF DESCRIPTION OF THE DRAWINGS

FIG. 1 is a front perspective view of the holder of the present invention;

FIG. 2 is a front plan view thereof;

FIG. 3 is a bottom plan view;

FIG. 4 is a cross-sectional view taken across line A-A of FIG. 2;

FIG. 5 is a front plan view of the holder mounted on a surface and securing a golf club; and

FIG. 6 is a from plan view of the holder attached to a surface and securing a shovel handle.

### DETAILED DESCRIPTION

The following is a detailed description of an embodiment of an easy open picture frame representing the best mode of working the invention presently known by the inventor.

The holder of the present invention is indicated generally be reference numeral 10 in the various drawings. Holder 10, as shown, has a base 12, a first gripping or securing element referred to as a gripper 14 and a second, opposed gripper 16.

Base 12, as shown, has a relatively elongated, substantially flat body 18 with a first end wall 20 at one end of the body and a second end wall 22 at the second end of the body and can be referred to as base, a base plate or just a plate. However, any acceptable structure can function as a base and it does not need to be configured as a plate. In the illustrated base the two end walls are orientated at right angles to the body. The two end walls can be a party of body 18 bent into this perpendicular configuration or can be separate elements fixed to the body by welding or other means. Body 18, as illustrated, includes a series of openings 24 along a top margin and a series of openings 25 along the bottom margin. As shown the openings 24, 25 are circular holes, but any shape will suffice. The openings 24 and 25 are employed if base plate 12 is attached directed to a surface, such as a wall or like with attachment apparatus such as screws, nails, rivets or other apparatus. It will be understood that although a plurality of openings are shown, one or more openings that accommodate attachment apparatus will work. By way of example only, one centrally placed opening and screw could secure the base to a surface. In a preferred embodiment, base plate 12 is constructed from a rugged, maintenance free material, such as stainless steel. However, any other material that functions satisfactorily for a base plate can be used.

Grippers 14 and 16 are mirror images of each other. The grippers have a substantially lobe-like configuration comprising a body section 26 having a top wall 28 that includes a depression 29 adjacent a first end and then curves down to a heel section 30 at the opposite end. Body section 26 also includes an arcuate bottom wall 32 that extends upwardly from the heel section and terminates in a nose section 34 at the first end defined by depression 29 and bottom wall 32. As shown, bottom wall 32 has a plurality of laterally orientated grooves 36 formed therein forming a gripping surface on the gripper. Grippers 16 and 16 are constructed from a semi rigid material having a high coefficient of friction, such as a hard rubber or similar material.

Moreover, the gripper bodies could be formed from an alternative material, such as a lightweight metal or the like and then coated or covered with a material having a high coefficient of friction. The grippers can be constructed without the lateral grooves and bottom wall 32 still function satisfactory as a gripping surface due to the tackiness of the material itself. The rubber has an advantage in that it does not mark or mar an object secured in holder 10.

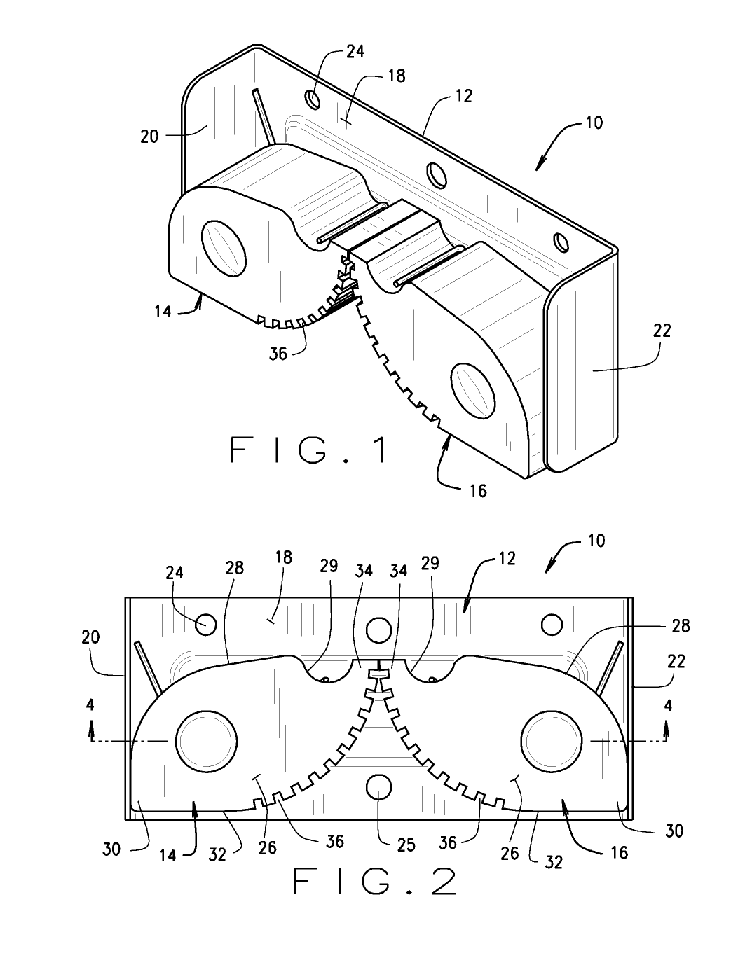

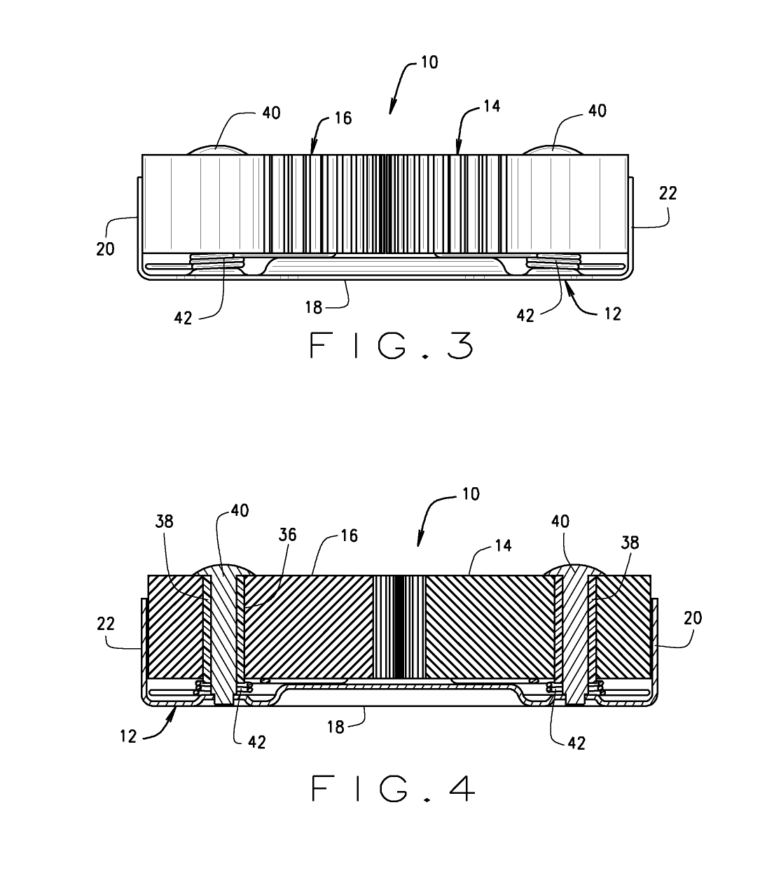

Each gripper 14 and 16 includes a bore 36 in the body section. As best seen in FIG. 4, there is a bushing sleeve 38 seated in each bore. In a preferred embodiment bushing sleeve 38 is made of a durable polymer material, such as nylon. Also as seen in FIG. 4 there is a rivet 40 inserted through bushing sleeve 38 and secured in base plate 12. Rivet 40 functions as an axle or pivot such that grippers 14 and 15 are rotatably mounted to base plate 12. Bushing sleeve 38 prevents excessive wear on the gripper material that could result if rivet 40 was introduced directly into bore 36. As best seen in FIGS. 3 and 4, there is a biasing apparatus, for example a stainless steel torsion spring 42 that urges each gripper nose towards each other, as seen in FIGS. 1 and 2. In this position, the noses are in contact with each other and heel section 30 abuts the respective end walls 20 and 22. This abutting relationship keeps spring 42 from forcing the grippers out of useful alignment.

Although the biasing apparatus shown is a torsion spring, any type of spring that effects the biasing action can be employed. Moreover, biasing apparatus other than springs can be used. For example, as structure, such as an axle or the like, could extend from the back side of the gripper. The axle would replace rivet 40 and could include integral biasing apparatus such as a clock spring or other type of biasing apparatus.

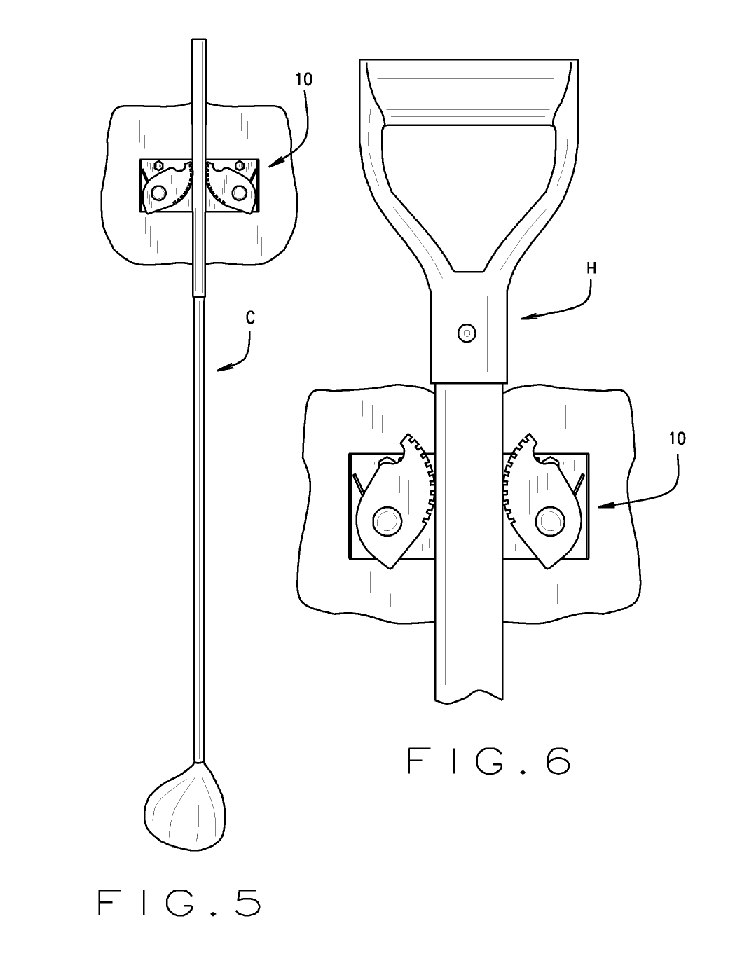

In any event, holder 10 works well to secure objects in place for storage, as seen in FIGS. 5 and 6. In use, the object to be secured is placed against the closed grippers and an upward, inward pressure applied to overcome the biasing force of the springs and spread them apart until the object can be inserted or slid between the grippers. Because grippers 14, 16 are biased into a closed position, a very narrow or smaller diameter object can be secured between the grippers. Although shown in FIG. 5 securing a relatively small diameter golf club C, holder 10 actually could secure an object as thin as a piece of paper. Moreover, the grippers can be urged apart to accommodate larger objects, such as shovel handle H. In one aspect of the invention, holder 10 can secure objects having a diameter of approximately 1⅞ inches.

When the object, such has handle H, is secured between grippers 14 and 16 grooves 36 contact the surface of the object, the grooves increase the coefficient of friction to help secure the object in place. Moreover, downward pressure of the object, for example the effect of its weight, effectively rotates or pulls the grippers down adding additional securing force. In fact, the more downward pressure placed on the object, the tighter the grippers grip the object. To remove the object, an upward and outward pressure is applied on the object to release it from the grippers.

Base plate 12 can be directly attached to a surface, such as a wall by attachment apparatus such as screws 44 inserted through openings 24, 25. Base plate 12 could be attached to a magnetic backing and holder 10 could then be removably attached to a metal structure, such as a metal cabinet. A plurality of holders hold be employed on a strip and the strip mounted on a surface as desired. The various ways the holder can be used are unlimited.

It will be appreciated by one skilled in the art that various changes and modifications can be made without departing from the scope of the invention. The detailed description and figures are intended to be illustrative of an aspect of the invention, as well as the best mode presently known of working the invention, and should not be viewed in a limiting sense.

1. A holder for securing objects, comprising:
a base for attachment to a surface;
a pair of opposed grippers rotatably mounted on the plate, the grippers being mirror images of each other, each gripper having a gripping surface;
a biasing apparatus associated with each gripper to bias the grippers toward each other, said biasing apparatus exerting a biasing force on the grippers when an object is positioned between the respective gripping surfaces to secure the object in place.

2. The holder of claim 1 wherein the grippers are formed from rubber having a relatively high coefficient of friction.

3. The holder of claim 1 wherein each gripper is configured having a body, a heel end, an upwardly arcing nose on the body opposite the heel with the gripping surface between the heel and the nose.

4. The holder of claim 1 wherein each gripping surface has a plurality of laterally extending grooves therein.

5. The holder of claim 1 wherein the biasing apparatus is a torsion spring.

6. The holder of claim 1 wherein the base includes a magnetic structure for releasable attachment of the holder to a surface.

7. The holder of claim 1 wherein the base defines at least one opening for attachment apparatus to attach the base to a surface.

8. A holder for securing objects, comprising:
a base plate for securing to a surface;
a pair of opposed grippers rotatably mounted on the plate, grippers being mirror images of each other and configured having a body, a heel end, an upwardly arcing nose on the body opposite the heel and a gripping surface between the heel and the nose;
a spring associated with the grippers to rotate the grippers toward each other such that the noses abut each other when there is no object between the grippers, said spring exerting a biasing force on the grippers to secure an object between the respective gripping surfaces when an object is introduced between the grippers.

9. The holder of claim 8 wherein the grippers are formed from rubber having a relatively high coefficient of friction.

10. The holder of claim 8 wherein each gripping surface has a plurality of laterally extending grooves therein.

11. The holder of claim 8 wherein the spring is a torsion spring.

12. The holder of claim 8 wherein the base plate includes a magnetic structure for releasable attachment of the holder to a surface.

13. The holder of claim 8 wherein the base plate defines at least one opening for attachment apparatus to attach the base to a surface.

14. A holder for securing objects, comprising:
a base plate comprising a substantially flat body for securing to a surface, a first end wall at a first end of the base plate and a second end wall at the second end of the base plate;
a first gripper rotatably mounted on the plate adjacent the first end wall and a second gripper rotatably mounted on the base plate adjacent the second end wall, the recited grippers being mirror images of each other with each gripper comprising a material having a high coefficient of friction, a body, a heel end, an upwardly arcing nose on the body opposite the heel and a gripping surface defining a plurality of laterally extending grooves between the heel and the nose;
a torsion spring operably associated with the grippers to rotate the grippers toward each other such that the noses abut each other when there is no object between the grippers, said torsion spring exerting a biasing force on the grippers to secure an object between the respective gripping surfaces when an object is introduced between the grippers; and
apparatus for attaching the base plate to a surface.

15. The holder of claim 14 wherein the apparatus for attaching the base to a surface further comprises at least one opening defined by the base plate and an attachment apparatus inserted through the at least one opening to attach the base plate to the surface.

16. The holder of claim 14 wherein the apparatus for attaching the base to a surface comprises a magnet.
